(19) United States
(12) Patent Application Publication
(10) Pub. No.: US 2023/0392933 A1
(43) Pub. Date: Dec. 7, 2023

(54) SHIP ARRIVAL PREDICTION SYSTEM AND METHOD THEREOF

(71) Applicant: Shanghai Maritime University, Shanghai (CN)

(72) Inventors: Guangnian XIAO, Shanghai (CN); Yuanshuai OU, Shanghai (CN); Qingan CUI, Shanghai (CN); Bangping GU, Shanghai (CN); Yu XIAO, Shanghai (CN); Tian WANG, Shanghai (CN); Liu CHEN, Shanghai (CN); Chunyu WANG, Shanghai (CN)

(73) Assignee: Shanghai Maritime University, Shanghai (CN)

(21) Appl. No.: 17/878,790

(22) Filed: Aug. 1, 2022

(30) Foreign Application Priority Data
Jun. 7, 2022 (CN) 202210634375.8

(51) Int. Cl. G01C 21/20; G06Q 10/04

(52) U.S. Cl. CPC G01C 21/203; G06Q 10/04

(57) ABSTRACT

Disclosed are a ship arrival prediction system and a ship arrival prediction method. The system includes a data acquisition module for acquiring historical sample data of a ship arrival; a data processing module connected with the data acquisition module and used for processing the historical sample data and converting the processed data into a two-dimensional matrix; a spatial temporal graph convolution layer module connected with the data processing module and used for modeling the converted data and obtaining optimal model parameters through training operations; and a full connection module connected with the spatial temporal graph convolution layer module and used for carrying out a dimensional reconstruction on an output result of the spatial temporal graph convolution layer module and outputting to obtain a predictive value of the ship arrival in each port.

### CROSS-REFERENCE TO RELATED APPLICATIONS

This application claims priority to Chinese Patent Application No. 202210634375.8, filed on Jun. 7, 2022, the contents of which are hereby incorporated by reference.

### TECHNICAL FIELD

The application belongs to the field of big data analysis of port and shipping logistics, and in particular relates to a ship arrival prediction system and a ship arrival prediction method.

### BACKGROUND

Ship arrivals are not only affected by economic and other factors, but also has a volatility, and generally shows an increasing trend. Therefore, in 2018, scholars of Zhejiang Ocean University proposed to combine cubic exponential smoothing with a grey Markov chain prediction model to establish a grey Markov chain optimization prediction model for the ship arrival. An accuracy of the prediction model is secured for random events with an increasing relationship. However, as long as there are decreasing abnormal points, the accuracy is greatly impaired.

In addition, the grey Markov chain prediction model lacks a joint modelling of a time dimension and a spatial dimension, so a prediction accuracy is not satisfactory. Ship travel data generated based on a shipping trade network has an obvious non-Euclidean structure, and its data features an irregular arrangement and a complex spatial topological structure. A conventional deep learning model may not deal with this kind of data structure effectively, and an appearance of a graph neural network fills a gap in this part and realizes an effective combination of graph data and the deep learning model. Scholars have modelled and predicted a road traffic flow for a road traffic network and achieved good results by using a graph convolution network. A waterway network and a road network have certain similarities, so the graph neural network is considered to model the waterway network and its shipping traffic.

In order to solve a problem that it is difficult to predict the ship arrivals with a high efficiency and the high accuracy in the prior art, a ship arrival prediction system, a ship arrival prediction method and a ship arrival prediction device are urgently needed.

### SUMMARY

Aiming at a deficiency of the prior art that it is difficult to fully extract spatial temporal features of a ship driving, and then it is difficult to predict a ship arrival with a high efficiency and a high accuracy, the application provides a ship arrival prediction system and a ship arrival prediction method with advantages of few parameters, the high efficiency and the high prediction accuracy.

In order to achieve the above objective, the application provides following schemes. The ship arrival prediction system includes:
a data acquisition module for acquiring historical sample data of a ship arrival;
a data processing module connected with the data acquisition module and used for processing the historical sample data and converting the processed data into a two-dimensional matrix;
a spatial temporal graph convolution layer module connected with the data processing module and used for modelling the converted data and obtaining optimal model parameters through training operations; and
a full connection module connected with the spatial temporal graph convolution layer module and used for carrying out a dimensional reconstruction on an output result of the spatial temporal graph convolution layer module and outputting to obtain a predictive value of the ship arrival in each port.

Optionally, the data processing module includes a data cleaning unit and a data conversion unit;
the data cleaning unit is used for removing a noise and inconsistent sample data from the historical sample data, and completing default values based on a linear interpolation method;
and the data conversion unit is used for converting the cleaned data into a two-dimensional matrix in combination with port ship arrival information.

Optionally, the spatial temporal graph convolution layer module includes a first spatial temporal convolution layer unit and a second spatial temporal convolution layer unit;
the first spatial temporal convolution layer unit is used for performing a first spatial temporal graph convolution operation on an input two-dimensional matrix to obtain a first operation result; and
the second spatial temporal convolution layer unit is used for performing a second spatial temporal graph convolution operation according to the first operation result, obtaining a second operation result, and outputting the second operation result to a full connection unit.

Optionally, the first spatial temporal convolution layer unit and the second spatial temporal convolution layer unit each includes a first gated causal convolution layer and a second gated causal convolution layer;
the first gated causal convolution layer is used for extracting time features for a first time; and
the second gated causal convolution layer is used for extracting time features for the second time.

Optionally, the full connection module includes a dimension reconstruction unit, a feature conversion unit and a prediction unit;
the dimension reconstruction unit is used for reconstructing dimensions according to the optimal model parameters;
the feature conversion unit is used for converting a feature dimension after the dimension reconstruction to obtain an output result meeting dimension requirements; and
the prediction unit is use for predicting according to the output result, and obtaining the predictive value of the ship arrival in each port.

A ship arrival prediction method includes:
acquiring historical sample data of a ship arrival, processing the historical sample data, and converting processed data into a two-dimensional matrix; modelling the converted data, and obtaining optimal model parameters through training operations; carrying out a dimensional reconstruction based on the optimal model parameters, and outputting a predictive value of the ship arrival in each port.

Optionally, a process of processing the historical sample data and converting the processed data into the two-dimensional matrix includes:
removing a noise and inconsistent sample data from the historical sample data by a data cleaning unit, and completing default values based on a linear interpolation method; and converting cleaned data into the two-dimensional matrix based on a data conversion unit.

Optionally, the process of removing the noise and the inconsistent sample data from the historical sample data, completing the default values, and converting the cleaned data into the two-dimensional matrix includes:
screening and grouping data records uploaded by ships on a same day based on the historical sample data of the ship arrival; obtaining dynamic information of a same freight line based on the information of a departure port and a destination port in the data records, and grouping the data records and arranging the data records in an ascending order by time stamps;
calculating a relative distance of the ships corresponding to adjacent timestamp records based on latitude and longitude information in the historical sample data of the ship arrival, and screening and eliminating mutation points; completing the dynamic information of the mutation points and default dynamic information of other records by using the linear interpolation method based on the dynamic information of coordinates, headings and speeds of adjacent records that have been eliminated; dividing a whole day into time scales based on whole hours, and determining a boundary by presetting a time period, determining an ownership of the recorded time scales and marking the time scales; and
calculating the relative distance to judge whether the record marked with the time scale is located in the port based on the longitude and the latitude of the port; after marking a specific port, only keeping the first record of the continuously marked port records; counting a number of the records in groups from the marked specific port records with the port as a statistical unit, and getting a total number of the ships in different ports under the time scales in the same day; and constructing the two-dimensional matrix with a port ship arrival matrix as an example.

Optionally, the two-dimensional matrix is expressed as:

$$D = ( \begin{matrix}{d}_{11} & ⋯ & {d}_{1 j} & ⋯ & {d}_{1 n} \\ ⋮ & ⋱ & ⋮ & ⋱ & ⋮ \\ {d}_{i 1} & ⋯ & {d}_{ij} & ⋯ & {d}_{in} \\ ⋮ & ⋱ & ⋮ & ⋱ & ⋮ \\ {d}_{m 1} & ⋯ & {d}_{mj} & ⋯ & {d}_{mn}\end{matrix} ) ,$$

where dᵢⱼ indicates the ship arrival at the j port under the i time scale, with a total

of m time scales and n ports.

The application discloses following technical effects.
(1) The ship arrival prediction system and the ship arrival prediction method provided by the application are used for predicting a port ship arrival, enriching prediction methods of port the ship arrival.
(2) The method realizes a joint modelling of a time dimension and a spatial dimension, and improves the prediction accuracy of the port ship arrival.
(3) The method adopts the spatial temporal graph convolution neural network with fewer parameters and a higher training efficiency, improves a prediction speed of the model, and is convenient for a port berth arrangement and an inbound scheduling.

### BRIEF DESCRIPTION OF THE DRAWINGS

In order to more clearly explain embodiments of the application or technical solutions in the prior art, the following briefly introduces drawings that need to be used in the embodiments. Obviously, the drawings in the following description are only some embodiments of the application. For those of ordinary skill in the art, other drawings may be obtained according to these drawings without any creative effort.

FIG. 1 is a schematic diagram of a system structure according to an embodiment of the application.

FIG. 2 is a schematic structural diagram of a spatial temporal convolution unit according to an embodiment of the application.

FIG. 3 is the flow chart of a ship arrival prediction method in an embodiment of the application.

FIG. 4 is a flow chart of removing noisy and inconsistent sample data, completing default values, and converting cleaned data into a two-dimensional matrix in combination with port ship arrival information through a data cleaning and conversion unit in an embodiment of the application.

### DETAILED DESCRIPTION OF THE EMBODIMENTS

Technical solutions in embodiments of the application are clearly and completely described below with reference to drawings in the embodiments of the application. Obviously, the described embodiments are only part of the embodiments of the application, but not all of them. Based on the embodiment of the application, all other embodiments obtained by ordinary technicians in the field without creative labor are within the scope of the application.

In order to make the above objects, features and advantages of the application more obvious and understandable, the application is explained in further detail below with reference to the drawings and detailed description.

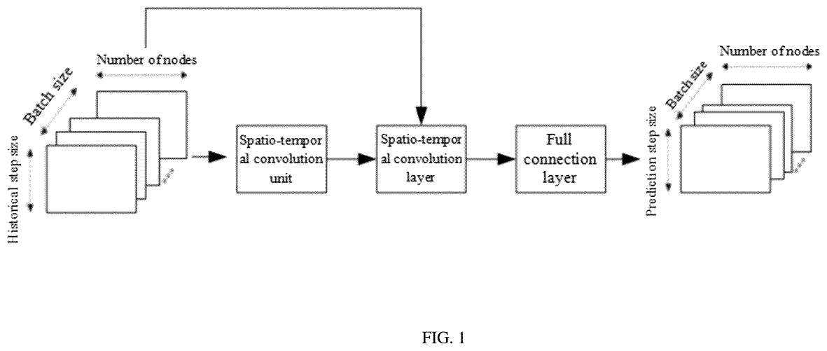

As shown in FIG. 1, the application provides a ship arrival prediction system and a ship arrival prediction method, and the system includes:
a data cleaning and conversion unit, which is used to remove noisy and inconsistent sample data, complete default values, and convert the cleaned data into a two-dimensional matrix in combination with port ship arrival information; a spatial temporal graph convolution layer unit, which models the converted data and seeks a set of optimal model parameters through training operations; and a full connection unit, which is used to convert a extracted feature dimension into a result that meets a requirement of an output dimension, and outputting a predictive value of a ship arrival in each port.

In an embodiment, the data cleaning and conversion unit in the ship arrival prediction system includes two subunits: a data cleaning subunit for removing incomplete, noisy and inconsistent sample data and completing the default values by a linear interpolation method; a data conversion subunit for converting the cleaned data into the two-dimensional matrix in combination with the port ship arrival information.

In an embodiment, the ship arrival prediction system includes two spatial temporal graph convolution layer units: a first spatial temporal graph convolution layer unit for performing a first spatial temporal graph convolution operation on the input two-dimensional matrix; a second spatial temporal graph convolution layer unit for performing a second spatial temporal graph convolution operation on the result of the first spatial temporal graph convolution layer unit, and outputting the result to the full connection unit.

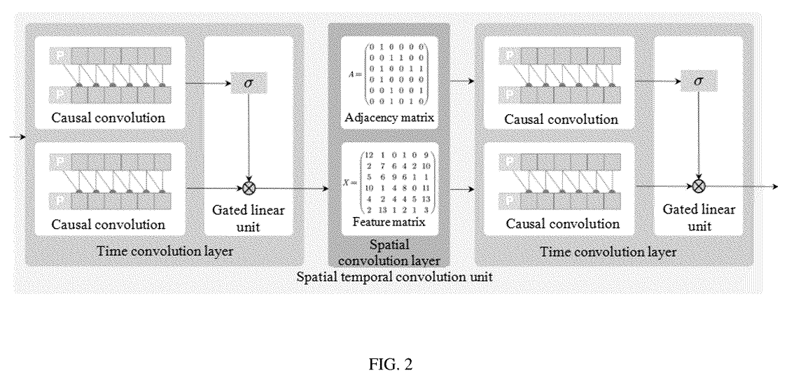

In an embodiment, structures of the first spatial temporal graph convolution layer unit and the second spatial temporal graph convolution layer unit in the ship arrival prediction system are the same, as shown in FIG. 2. The first spatial temporal graph convolution layer unit and the second spatial temporal graph convolution layer unit each includes: a first gated causal convolution layer with 64 convolution kernels for extracting time features; a spatial-based convolution layer for extracting spatial features; and a second gated causal convolution layer with 64 convolution kernels for extracting the time features again.

Existing forecasting methods lack a joint modelling of a time dimension and a spatial dimension. Moreover, the existing methods require many parameters and a long training time of the model, so a training efficiency of the model is affected. Therefore, in order to simultaneously capture features of the time dimension and the spatial dimension of the ship arrival and realize a high-efficiency prediction, the application provides a ship arrival prediction method based on a spatial temporal graph convolution neural network model.

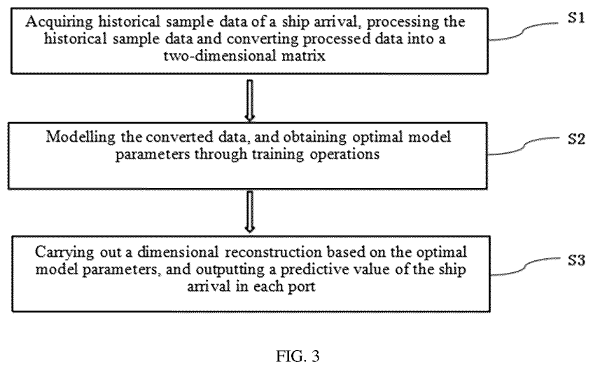

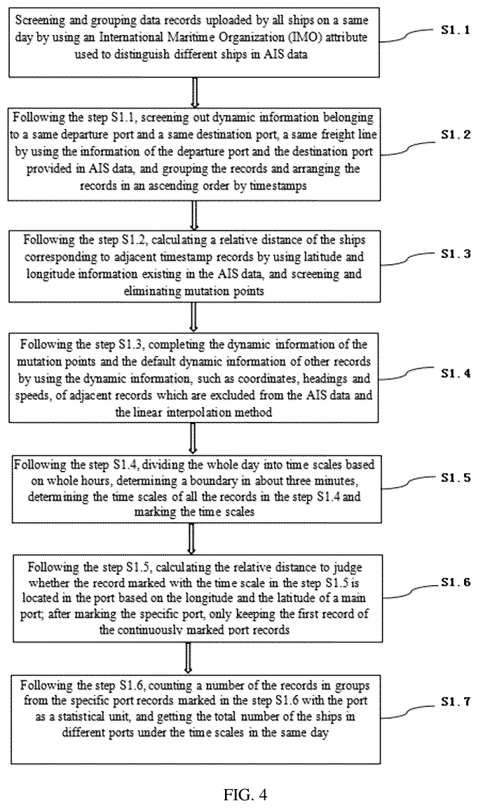

As shown in FIG. 3, the ship arrival prediction method includes following steps:
S1 removing the noisy and inconsistent sample data through the data cleaning and conversion unit, completing the default values, and converting the cleaned data into the two-dimensional matrix by combining with the port ship arrival information; as shown in FIG. 4:
S1.1 screening and grouping data records uploaded by all ships on a same day by using an International Maritime Organization (IMO) attribute used to distinguish different ships in AIS data;
S1.2 following the step S1.1, screening out dynamic information belonging to a same departure port and a same destination port, a same freight line by using the information of the departure port and the destination port provided in AIS data, and grouping the records and arranging the records in an ascending order by timestamps;

S1.3 following the step S1.2, calculating a relative distance of the ships corresponding to adjacent timestamp records by using latitude and longitude information existing in the AIS data, and screening and eliminating mutation points;
S1.4 following the step S1.3, completing the dynamic information of the mutation points and the default dynamic information of other records by using the dynamic information, such as coordinates, headings and speeds, of adjacent records which are excluded from the AIS data and the linear interpolation method;
S1.5 following the step S1.4, dividing the whole day into time scales based on whole hours, determining a boundary in about three minutes, determining the time scales of all the records in the step 1.4 and marking the time scales;

S1.6 following the step S1.5, calculating the relative distance to judge whether the record marked with the time scale in the step S1.5 is located in the port based on the longitude and the latitude of a main port; after marking the specific port, only keeping the first record of the continuously marked port records;
S1.7 following the step S1.6, counting a number of the records in groups from the specific port records marked in the step S1.6 with the port as a statistical unit, and getting the total number of the ships in different ports under the time scales in the same day; and constructing the following two-dimensional matrix with a port ship arrival matrix as an example:

$$D = ( \begin{matrix}{d}_{11} & ⋯ & {d}_{1 j} & ⋯ & {d}_{1 n} \\ ⋮ & ⋱ & ⋮ & ⋱ & ⋮ \\ {d}_{i 1} & ⋯ & {d}_{ij} & ⋯ & {d}_{in} \\ ⋮ & ⋱ & ⋮ & ⋱ & ⋮ \\ {d}_{m 1} & ⋯ & {d}_{mj} & ⋯ & {d}_{mn}\end{matrix} ) ,$$

among them, dᵢⱼ indicates the ship arrival at the j port under the i time scale, with a total of m time scales and n ports;
S2 modelling the converted data by the spatial temporal graph convolution layer unit, and seeking a set of optimal model parameters through training operations; and
S3 carrying out a dimension reconstruction on the output results of the spatial temporal graph convolution layer unit through the full connection unit, and outputting the predictive value of the ship arrival.

To evaluate an effect of the embodiment of the application, the prediction accuracy of the method provided by the application is verified by using the public AIS data provided by MarineCadastre.gov. Methods: conventional recurrent neural network (method 1), long-term and short-term memory neural network (method 2) and gated recurrent unit network (method 3) are used as benchmarks. Verification indexes are symmetrical mean absolute percentage error (SMAPE), root mean square error (RMSE) and mean absolute error (MAE) respectively. Calculation formulas are:

$$S M A P E = \frac{100 \%}{qn} {\sum }_{i = 1}^{q} {\sum }_{j = 1}^{n} \frac{\vert {\hat{d}}_{ij}^{*} - {d}_{ij} \vert}{( \vert {\hat{d}}_{ij}^{*} \vert + \vert {d}_{ij} \vert ) / 2} ,$$

$$R M S E = \sqrt{\frac{1}{qn} {\sum }_{i = 1}^{q} {\sum }_{j = 1}^{n} {( {\hat{d}}_{ij}^{*} - {d}_{ij} )}^{2}} ,$$

$$M A E = \frac{1}{qn} {\sum }_{i = 1}^{q} {\sum }_{j = 1}^{n} \vert {\hat{d}}_{ij}^{*} - {d}_{ij} \vert ,$$

where q indicates a number of predicted samples, dᵢⱼ and \hat{d}*ᵢⱼ respectively indicate an actual value and a prediction value of the ship arrival at the j port on the i time scale.

This embodiment also provides a ship arrival prediction device, including a non-temporary computer storage medium for storing programs. The program includes: a data cleaning and conversion unit, which is used to remove noisy and inconsistent sample data, complete default values, and convert the cleaned data into a two-dimensional matrix in combination with port information; a spatial temporal graph convolution layer unit, which models the converted data and seeks a set of optimal model parameters through training operations; and a full connection unit, which is used to reconstruct a dimension of an output result of the spatial temporal graph convolution layer unit, and output a predictive value of a port ship arrival.

In view of a fact that the ship arrival is on the increase for a long time, it is very important to predict the ship arrival based on a predicting theory for a rational planning of a port anchorage and an efficient management of a waterway traffic. The application provides a ship arrival prediction system and a ship arrival prediction system scheme, so as to bring remarkable effects from social benefits and economic benefits.

### Social Benefits

A level of port intelligence is improved. The prediction of the ship arrival effectively improves the level of information processing and related technical capabilities.

Carbon emissions are reduced. The prediction of the ship arrival manages the waterway traffic more efficiently, thus reducing unnecessary time for the ships to stop at the ports, and thus reducing the carbon emissions of the ships.

A labor burden of workers is reduced. Congestion of docks has led to an increase in the labor burden of the workers in many countries, and even strikes. The prediction of the ship arrival in the port is greatly helpful to weaken an occurrence of those situations.

### Economic Benefits

A soaring freight rate is effectively alleviated. The rational planning of the port anchorage and the efficient management of waterway transportation effectively improves the port congestion, thus alleviating the soaring freight rate.

Labor costs are reduced. Ship arrival prediction technology improves a port intelligence level, reduces a number of the port workers, and then reduce the labor costs.

The above-mentioned embodiments only describe a preferred mode of the application, but do not limit a scope of the application. On a premise of not departing from a design spirit of the application, all kinds of modifications and improvements made by ordinary technicians in the field to the technical scheme of the application shall fall within the scope of protection determined by the claims of the application.

What is claimed is:

1. A ship arrival prediction system, comprising:
a data acquisition module for acquiring historical sample data of a ship arrival;
a data processing module connected with the data acquisition module and used for processing the historical sample data and converting processed data into a two-dimensional matrix;
a spatial temporal graph convolution layer module connected with the data processing module and used for modelling converted data and obtaining optimal model parameters through training operations; and
a full connection module connected with the spatial temporal graph convolution layer module and used for carrying out a dimensional reconstruction on an output result of the spatial temporal graph convolution layer module and outputting to obtain a predictive value of the ship arrival in each port.

2. The ship arrival prediction system according to claim 1, wherein,
the data processing module comprises a data cleaning unit and a data conversion unit;
the data cleaning unit is used for removing a noise and inconsistent sample data from the historical sample data, and completing default values based on a linear interpolation method; and
the data conversion unit is used for converting the cleaned data into the two-dimensional matrix in combination with port ship arrival information.

3. The ship arrival prediction system according to claim 1, wherein,
the spatial temporal graph convolution layer module comprises a first spatial temporal convolution layer unit and a second spatial temporal convolution layer unit;
the first spatial temporal convolution layer unit is used for performing a first spatial temporal graph convolution operation on an input two-dimensional matrix to obtain a first operation result; and
the second spatial temporal convolution layer unit is used for performing a second spatial temporal graph convolution operation according to the first operation result, obtaining a second operation result, and outputting the second operation result to a full connection unit.

4. The ship arrival prediction system according to claim 3, wherein,
each of the first spatial temporal convolution layer unit and the second spatial temporal convolution layer unit comprises a first gated causal convolution layer and a second gated causal convolution layer;
the first gated causal convolution layer is used for extracting time features for a first time; and
the second gated causal convolution layer is used for extracting time features for the second time.

5. The ship arrival prediction system according to claim 1, wherein,
the full connection module comprises a dimension reconstruction unit, a feature conversion unit and a prediction unit;
the dimension reconstruction unit is used for reconstructing dimensions according to the optimal model parameters;
the feature conversion unit is used for converting a feature dimension after the dimension reconstruction to obtain output result meeting dimension requirements; and
the prediction unit is used for predicting according to the output result, and obtaining the predictive value of the ship arrival in each port.

6. A ship arrival prediction method, comprising:
acquiring historical sample data of a ship arrival, processing the historical sample data and converting processed data into a two-dimensional matrix;
modelling the converted data, and obtaining optimal model parameters through training operations; and
carrying out a dimensional reconstruction based on the optimal model parameters, and outputting a predictive value of the ship arrival in each port.

7. The ship arrival prediction method according to claim 6, wherein processing the historical sample data and converting the processed data into the two-dimensional matrix comprises:
removing a noise and inconsistent sample data from the historical sample data by a data cleaning unit, and completing default values based on a linear interpolation method; and converting cleaned data into the two-dimensional matrix based on a data conversion unit.

8. The ship arrival prediction method according to claim 7,
wherein removing the noise and the inconsistent sample data from the historical sample data and completing the default values comprises:
screening and grouping data records uploaded by ships on a same day based on the historical sample data of the ship arrival; obtaining dynamic information of a same freight line based on the information of a departure port and a destination port in the data records, and grouping the data records and arranging the data records in an ascending order by time stamps;
calculating a relative distance of the ships corresponding to adjacent timestamp records based on latitude and longitude information in the historical sample data of the ship arrival, and screening and eliminating mutation points; completing the dynamic information of the mutation points and default dynamic information of other records by using the linear interpolation method based on the dynamic information of coordinates, headings and speeds of adjacent records that have been eliminated; dividing a whole day into m time scales based on whole hours, and determining a boundary by presetting a time period, determining an ownership of the recorded time scales and marking the time scales; and
wherein converting the cleaned data into the two-dimensional matrix comprises:
calculating the relative distance to judge whether the record marked with the time scale is located in the port based on the longitude and the latitude of the port; after marking a specific port, only keeping the first record of the continuously marked port records; counting a number of the records in groups from the marked specific port records with the port as a statistical unit, and getting a total number of the ships in different ports under the m time scales in the same day; and constructing the two-dimensional matrix with a port ship arrival matrix as an example.

9. The ship arrival prediction method according to claim 6, wherein,
the two-dimensional matrix is expressed as:
$$D = ( \begin{matrix}{d}_{11} & ⋯ & {d}_{1 j} & ⋯ & {d}_{1 n} \\ ⋮ & ⋱ & ⋮ & ⋱ & ⋮ \\ {d}_{i 1} & ⋯ & {d}_{ij} & ⋯ & {d}_{in} \\ ⋮ & ⋱ & ⋮ & ⋱ & ⋮ \\ {d}_{m 1} & ⋯ & {d}_{mj} & ⋯ & {d}_{mn}\end{matrix} ) ,$$
wherein, dᵢⱼ indicates the ship arrival at the j port under the i time scale, with a total of m time scales and n ports.
